(19) United States
(12) Patent Application Publication
(10) Pub. No.: US 2006/0047779 A1
(43) Pub. Date: Mar. 2, 2006

(54) HTTP agent-driven content negotiation for scalable video coding

(75) Inventor: Sachin G. Deshpande, Vancouver, WA (US)

Correspondence Address: SHARP LABORATORIES OF AMERICA, INC, 5750 NW PACIFIC RIM BLVD, CAMAS, WA, 98642, US

(73) Assignee: Sharp Laboratories of America, Inc.

(21) Appl. No.: 10/890,796

(22) Filed: Jul. 12, 2004

(51) Int. Cl. G06F 15/16

(52) U.S. Cl. 709/218

(57) ABSTRACT

A client can discover the quality-selection parameters that are available from a server for a particular scalable-coded video resource using an HTTP-based agent-driven content negotiation technique. A client sends an HTTP-based request to a server for a list of variants of the resource. The server receives the HTTP-based request and, in response, generates and sends to the client an HTTP-based response containing a list of available variants. The list of available variants can be based on at least one of a resolution, a frame rate, a bit-rate and a color depth. The client then selects an appropriate variant for consumption at the client.

### CROSS-REFERRENCE TO RELATED APPLICATIONS

The present application claims priority to U.S. Provisional Patent Application No. (Attorney Docket No. SLA1639P), filed Jun. 22, 2004, entitled “HTTP Agent-Driven Content Negotiation For Scalable Video Coding,” invented by Sachin Deshpande, and which is incorporated herein by reference.

### BACKGROUND OF THE INVENTION

1. Field of the Invention

The present invention relates to streamed content systems. In particular, the present invention relates to a system and a method for identifying for a client the various supported quality-selection parameters that are available from a server for a particular scalable-coded video resource.

2. Description of the Related Art

A requirement for scalable video coding (SVC), as defined in the Requirements and Applications for Scalable Video Coding document, is a system interface that supports a quality selection mechanism through which a sending system (or source) dynamically generates different target frame rates, bit rates and resolutions from a stored bit stream based on the environment of a requesting client. See, for example, Section 2, Requirement 19 in ISO/IEC JTC1/SC29/WG11/N6025, “Requirements and Applications for Scalable Video Coding,” SVC Requirements, October 2003. Accordingly, the quality-selection parameters that are supported by a server for a particular scalable-coded video resource must be identified to a client so that the client can optimally consume the video resource.

What is needed is a technique for identifying for a client the various supported quality-selection parameters that are available from a server for a particular scalable-coded video resource.

### SUMMARY OF THE INVENTION

The present invention provides a technique for identifying for a client the various supported quality-selection parameters that are available from a server for a particular scalable-coded video resource.

The advantages of the present invention are provided by a system and a method in which a scalable-encoded resource, such as a scalable-encoded video resource, a scalable-encoded audio resource or a scalable-encoded image resource, is available in a plurality of variants. A client sends an HTTP-based request to a request receiver for a list of variants of the resource. The request receiver receives the HTTP-based request and, in response, generates and sends to the client an HTTP-based response containing a list of available variants. According to the present invention, the list of available variants is based on at least one of a resolution, a frame rate, a bit-rate and a color depth in which at least one variant is specified by a discrete value. Alternatively, at least one variant could be specified by a range of values. Typically, at least one variant is represented by a Uniform Resource Locator (URL) that can be an HTTP-based URL. Alternatively, the URL could be a non-HTTP-based URL.

The HTTP-based response includes a header, such as an Alternates response header, containing the list of available variants. The header could also include a custom header field containing the list of available variants. The header could also include a Location header containing a URL pointing to a default variant. Additionally, or in the alternative, the HTTP-based response could further include an entity that further contains the list of variants in a plain text-based format and/or an HTML-based format and/or including at least one description relating to a frame-rate, a bit-rate, a resolution, a quality and a color depth.

In one embodiment of the present invention, the client automatically selects a variant based on one of a resolution, a frame rate and a bit-rate. In an alternative embodiment of the present invention, a variant is manually selected at the client from a list of variants that have been displayed.

### BRIEF DESCRIPTION OF THE DRAWINGS

The present invention is illustrated by way of example and not by limitation in the accompanying figures in which like reference numerals indicate similar elements and in which:

FIG. 1 depicts a functional block diagram of an exemplary system utilizing an HTTP-based agent-driven content negotiation technique for client-side quality selection of a scalable-coded video resource according to the present invention; and

FIG. 2 depicts a flow diagram illustrating an HTTP-based agent-driven content negotiation technique for client-side quality selection of a scalable-coded video resource according to the present invention.

### DETAILED DESCRIPTION OF THE PRESENT INVENTION

The following description of the present invention is based on terminology that is defined in R. Fielding et al., “Hyper-text Transfer Protocol—HTTP/1.1,” RFC 2616, June 1999, which is incorporated by reference herein. In particular, the term “resource,” as used herein, means a network data object or service that can be identified by a Uniform Resource Identifier (URI). Accordingly, a resource may be available in multiple representations (e.g., multiple languages, data formats, size, and resolutions) or vary in other ways. The term “entity,” as used herein, means the information that is transferred as a payload of a request or a response. An entity can include metainformation in the form of entity-header fields and content in the form of an entity body. The term “representation,” as used herein, means an entity that is included with a response that is subject to content negotiation. There may exist multiple representations associated with a particular response status. “Content negotiation,” as used herein, is a mechanism for selecting an appropriate representation when a request is serviced. Representation of entities in any response can be negotiated, including error responses. A resource may have one or more representations associated with the resource at any given instant. Each representation of the resource is referred to herein as a “variant.” It should be noted, though, that use of the term “variant,” as used herein, does not necessarily imply that the resource associated with the variant is subject to content negotiation.

Additionally, as used herein, text in a Courier font represents an HTTP primitive or method.

The present invention provides an HTTP-based agent-driven content negotiation technique for supporting client-side quality selection of a scalable-coded video resource. According to the present invention, a client can automatically “discover” the quality parameters that are supported for a scalable-coded video resource using HTTP-based techniques. After the client has “discovered” the quality selections that are available, the client automatically selects a variant of the resource that is optimal for the client. Alternatively, an optimal resource can be selected manually by a user of the client. A selected variant could be streamed to the client using a protocol other than an HTTP-based protocol, such as RTSP with RTP. The server can store a scalable-coded video resource as either a single or as multiple physical and/or logical resources and variants.

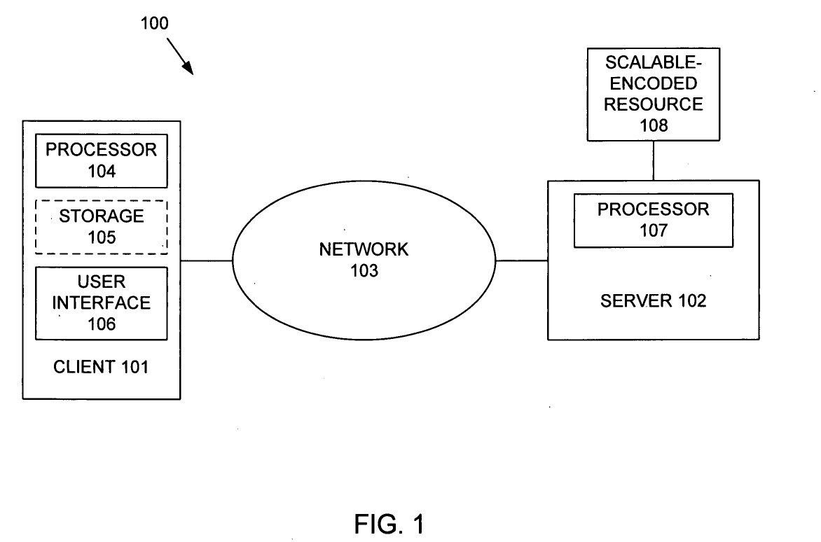

FIG. 1 depicts a functional block diagram of an exemplary system 100 utilizing an HTTP-based agent-driven content negotiation technique for client-side quality selection of a scalable-coded video resource according to the present invention. System 100 includes a client device 101 that is coupled to a server 102 through a network 103, such as the Internet. Network 103 could alternatively be a Wide Area Network (WAN) other than the Internet. Client device 101 includes a processor 104, storage 105 and a user interface 106. Processor 104 can be capable of decoding a plurality of different data-encoding schemes. Alternatively, processor 104 could only have capability of decoding a specific data-encoding scheme. In one exemplary embodiment, storage 105 stores configuration information for client device 101 in a well-known manner. In an alternative embodiment, system 100 does not include storage 105 and is thus depicted with a dashed line. In one exemplary embodiment, user interface operates to automatically select an appropriate variant for client device 101. In another exemplary embodiment, user interface 106 displays a list of variants for each requested resource and then allows a user to manually select the appropriate variant from the server based on, for example, a user's knowledge of the client environment and/or a personal preference of the user.

Server 102 includes a processor 107 that receives requests for resource 108. A scalable-encoded video resource 108 is available through server 102. Server 102 represents scalable-coded resource 108 by a single Uniform Resource Identifier (URI), such as by the symbol URL1. The scalable coded resource maybe stored on server 102 or may be stored on an alternative physical location (not shown), which is accessible to server 102. The symbol URL1, as used herein, represents an exemplary scalable-coded video resource. URL1 will typically be available for client 101 to consume in multiple variants, such as in multiple resolutions, in multiple frame rates and/or in multiple bit-rates, etc. The ways in which the variants for a negotiable resource vary are referred to herein as the dimensions of negotiation. For a scalable-coded video, the typical dimensions for variants include different supported resolutions, frame rates, bit-rates, etc.

It should be understood that while only a single resource is depicted in FIG. 1, a plurality of scalable-encoded resources could be available through server 102. Additionally, it should be understood that system 100 could further include a plurality of client devices and a plurality of servers.

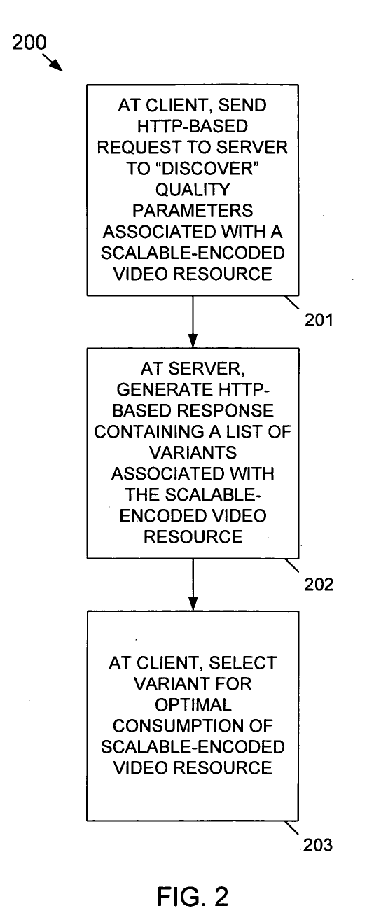

FIG. 2 depicts a flow diagram 200 illustrating an HTTP-based agent-driven content negotiation technique for client-side quality selection of a scalable-coded video resource according to the present invention. Referring to both FIG. 1 and FIG. 2, client device 101 sends an HTTP-based request, such as an HTTP GET request, to server 102 at step 201 to discover the quality parameters that are available for scalable-coded video resource 108. At step 202, server 102 generates an HTTP-based reply, such as an HTTP/1.1 status code 300 (Multiple Choices) response, that contains a list of the variants associated with resource 108. At step 203, a variant of resource 108 is selected at client device 101 for optimum consumption at client device 101.

In one exemplary embodiment of the present invention, a preferred variant choice, which can be consumed by a majority of clients, could be labeled in the response and automatically selected by a client. In another exemplary embodiment, recommended variants for a scalable-coded video resource could be labeled in the entity body and/or headers of the response.

While, in theory, a client may access a scalable-coded video stream using any scalability parameter, the number of quality-selection parameters selected by clients accessing the scalable-coded video resource may be limited. A non-intelligent client may have no ability to automatically select from among multiple available quality-selection parameters for optimal consumption. Consequently, the non-intelligent client would be required to access a default variant of the scalable-encoded video resource, which may not be an optimal variant for the non-intelligent client. An alternative exemplary embodiment of the present invention provides allows a variant to be selected for the non-intelligent client that is based on, for example, a user's knowledge of the client environment and/or a personal preference of the user.

While a scalable-coded video resource may have several variants, the present invention generally does not restrict the number of variants for a scalable-coded video resource. A content creator may, however, decide to list only a few of variants for a resource based on a few commonly encountered client types. For example, the variants most suitable for different common client network connection speeds, such as T1, DSL, cable modem, dial-up, may be listed in a response. In such a situation, the list of available variants would represent an initial entry point for a client to start a stream. During the transmission of a stream, the client and server may exchange further information in real-time in order to dynamically change or vary the stream transmission parameters, thereby adapting the stream to the current conditions.

Additionally or alternatively, the server may generate a list of available variants dynamically or statically from a previously created list of variants that is supplied by a content provider. The list-creation mechanism of the present invention is implementation dependent.

The server response can include the variant list in a response header and/or a response entity body. For example, when a response header is used, the response header may list the available variants that are associated with a scalable-coded video resource. For example, an HTTP response header Alternates is defined by K. Holtman et al., “Transparent Content Negotiation in HTTP,” RFC 2295, March 1998, that can be used by the present invention for conveying the list of variants associated with a negotiable resource. Alternatively, it is possible to define and use another header field and/or other fields appearing in a response header to return a list of variants.

In one exemplary embodiment in which an Alternates response header is used, a features attributes field is used for describing the available variants (variant-description). For this exemplary embodiment, the feature tags (ftag) x.framerate, x.bitrate, and x.resolution are used for feature-list-elements by respectively defining feature predicates that describe the characteristics features of the variant with respect to the frame rate, bit rate and resolution. The tag-values used in the feature predicates in the feature-list-elements respectively use the units of frames per second, and bits per second for the x.framerate and x.bitrate ftags. The tag-value for the x.resolution ftag can use a width×height format.

Alternatively, instead of using the features attribute when an Alternates response header is used, an extension-attributes field can be used to describe the variants (variant-description). For example:

extension-attribute = “{“ “x-framerate” 1*DIGIT [“.” 1*DIGIT] ”}”

| “{“ “x-bitrate” 1*DIGIT [“.” 1*DIGIT] ”}”
| “{“ “x-resolution” 1*DIGIT “x” 1*DIGIT ”}”

The extension-attribute defines three extension-names (x-framerate, x-bitrate and x-resolution) having extension-values that can be used for providing a client with information about the frame-rate, the bit-rate and the resolution of a variant for a scalable-coded video resource, respectively. The extension-values can respectively use the units of frames per second and bits per second for the x-framerate and x-bitrate extension-names. The extension-value for the extension-name x-resolution can use a width×height format.

The various features and/or extension attributes described thus far may be specified using discrete values for resolution, frame-rate and bit-rate. Alternatively, the various features and/or extension attributes could specify a supported range of values for the respective parameters (i.e., resolution, frame-rate and bit-rate). For example, a server may include the features and/or extension attributes when listing the variants using the Alternates header. Additional features and/or extension attributes, such as complexity characteristics, region-of-interest and color depth that are supported for a scalable-coded video resource, can be characterized by defining additional feature and/or extension attributes.

The Alternates response header represents available variants for the resource using URLs. A server-may use any mechanism to list the URLs for each variant. For example, when a server has created separate physical or virtual files to represent the variants, each URL would point to the respective physical and virtual files. Alternatively, a URL may point to a server script having different parameter values for different variants that are passed in the URL to the script. As yet another alternative, a URL that is used for a variant could be a non-HTTP URL.

The HTTP response from the server may additionally or alternatively include a Location header that contains a default URL that points to a representation of the scalable-coded video that could be consumed by a majority of the clients that are expected to request access to video resource. For example, a baseline profile could be defined having certain (minimum) parameters relating to a scalable-encoded video resource that all decoders are able to decode. The Location header could then point to a corresponding minimal/baseline representation of the scalable video resource so that a non-intelligent client would be able to consume at least the minimal/baseline representation baseline version of the scalable-coded video.

A response entity body may also list available variants. The media type provided by a Content-Type header field specifies the format of the entity. For example, a server may return the variant list in a plain text-based format and/or an HTML-based format. The list of variants could include descriptions for each respective variant, such as frame-rate, bit-rate, resolution, and/or other labels, such as DVD quality, VHS quality, etc., that may be useful for a manual selection of the variant by a user.

When the client receives the HTTP/1.1 300 (Multiple Choices) response, the client may display all the available variants returned in the response header and/or entity body to the user. Depending on the client configuration, a variant selection may be automatically made by the client or a user then may select a variant from the list of variants. Automatic variant selection could be based on a client device having a limited user interface that makes display and/or selection of available variants difficult. Alternatively, automatic variant selection could be based on a user configuration that has been previously stored in the client. As another alternative, automatic variant selection could be based on client capabilities so that an optimal representation for the client is provided from the server. When the client is a non-intelligent client, the user would view the available variants and their respective descriptions and select a variant for consumption based on a quality preference and/or parameter information and/or knowledge of the client environment (e.g., network connection speed etc.). Alternatively, a non-intelligent client may choose the variant listed in the Location header field of the response, as described above.

The following pseudo-code illustrates an exemplary server HTTP request sent from a client to a server:

GET /videos/svc1/svc1.var HTTP/1.1\r\n
Host: www.homeserver.com\r\n
Connection: close\r\n
\r\n

The following pseudo-code illustrates an exemplary client HTTP response sent from a server to a client:

HTTP/1.1 300 Multiple Choices\r\n
Date: Mon, 14 Jul 2003 23:35:08 GMT\r\n
Server: Apache/2.0.47 (Win32)\r\n
Alternates: {“svc.cgi?u=svc1.svc&r=3” 0.5 {type video/x-svc}
{length 50128542} {x-framerate 15} {x-bitrate 2480000} {x-
resolution 352×288}}, {“svc.cgi?u=svc1.svc&r=2” 0.7 {type
video/x-svc} {length 75243782} {x-framerate 20} {x-bitrate
4885000} {x-resolution 352×288}}, {“svc.cgi?u=svc1.svc&r=1” 1
{type video/x-svc} {length 100527534} {x-framerate 24} {x-
bitrate 7480000} {x-resolution 640×480}}, {“svc11.svc” 0.25
{type video/x-svc} {length 7486380} {x-framerate 10} {x-
bitrate 509000} {x-resolution 176×144}}
Vary: negotiate\r\n
TCN: list\r\n
Location: http://www.homeserver.com/videos/svc1/svc11.svc
Content-Length: 863\r\n
Connection: close\r\n
Content-Type: text/html; charset=iso-8859-1\r\n
\r\n
<!DOCTYPE HTML PUBLIC “-//IETF//DTD HTML 2.0//EN”>
<html><head>
<title>Variant List for svc1</title>
</head><body>
Available variants:
<ul>
<li><a href=“svc.cgi?u=svc1.svc&r=3”>256 Kbps SVC video
(Resolution 352×288, Frame-rate= 15 fps, Length=50128542
bytes)</a> , type video/x-svc</li>
<li><a href=“svc.cgi?u=svc1.svcr&=2”>512 Kbps SVC video
(Resolution 352×288, Frame-rate= 20 fps, Length=75243782
bytes)</a> , type video/x-svc</li>
<li><a href=“svc.cgi?u=svc1.svc&r=1”>750 Kbps SVC video
(Resolution 640×480, Frame-rate= 24 fps, Length=100527534
bytes)</a> , type video/x-svc</li>
<li><a href=“svc11.svc”>56 Kbps SVC video (Resolution 176×144,
Frame-rate= 10 fps, Length=7486380 bytes)</a> , type video/x-
svc</li>
</ul></ul>
<hr />
<address>Apache/2.0.47 (Win32) Server at www.homeserver.com
Port 8080</address>
</body></html>

In the exemplary pseudo-code response above, the Alternates header is used to return a variant list. The x-framerate, x-bitrate and x-resolution extension-attributes described above are also used. Alternatively, features attributes could have been used instead of extension attributes. The response could have also returned a Location header that points to the scalable-coded video at the lowest available bit-rate. In the above example, the response body returned a list of the available variants along with a description of each variant in an HTML format.

Although the foregoing invention has been described in some detail for purposes of clarity of understanding, it will be apparent that certain changes and modifications may be practiced that are within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A system, comprising:
a resource that is available in a plurality of variants; and
a request receiver receiving an HTTP-based request for the resource, the request receiver responding to the request by generating an HTTP-based response containing a list of available variants.

2. The system according to claim 1, wherein the resource is a scalable-encoded video resource.

3. The system according to claim 1, wherein the resource is a scalable-encoded audio resource.

4. The system according to claim 1, wherein the resource is a scalable-encoded image resource.

5. The system according to claim 1, wherein the list of available variants is based on at least one of a resolution, a frame rate, a bit-rate and a color depth.

6. The system according to claim 5, wherein at least one variant is specified by a discrete value.

7. The system according to claim 5, wherein at least one variant is specified by a range of values.

8. The system according to claim 1, wherein at least one variant is represented by a Uniform Resource Locator (URL).

9. The system according to claim 8, wherein the URL is an HTTP-based URL.

10. The system according to claim 8, wherein the URL is a non-HTTP-based URL.

11. The system according to claim 1, wherein the HTTP-based response includes a header containing the list of available variants.

12. The system according to claim 11, wherein the header is an Alternates response header.

13. The system according to claim 11, wherein the header includes an extension-attributes field describing the available variants.

14. The system according to claim 11, wherein the HTTP-based response further includes an entity that further contains the list of variants.

15. The system according to claim 1, wherein the HTTP-based response includes a header that contains a URL pointing to a default variant.

16. The system according to claim 15, wherein the header is a Location header.

17. The system according to claim 1, wherein the HTTP-based response includes an entity containing the list of variants.

18. The system according to claim 17, wherein the list of variants is in a plain text-based format.

19. The system according to claim 17, wherein the list of variants is in an HTML-based format.

20. The system according to claim 17, wherein the list of variants includes at least one description relating to a frame-rate, a bit-rate, a resolution, a quality and a color depth.

21. The system according to claim 1, wherein the HTTP-based response includes a features attribute describing at least one of a frame-rate, a bit-rate, a resolution and a color depth.

22. The system according to claim 1, wherein the HTTP-based response includes an extension attribute describing at least one of a frame-rate, a bit-rate, a resolution and a color depth.

23. The system according to claim 1, further comprising a client sending the HTTP-based request to the request receiver and receiving the HTTP-based response containing a list of available variants from the request receiver.

24. The system according to claim 23, wherein the client automatically selects a variant based on one of a resolution, a frame rate, a bit-rate and a color depth.

25. The system according to claim 23, wherein a variant is manually selected at the client.

26. The system according to claim 25, wherein the list of variants is displayed for manual selection.

27. A system, comprising
a request generator sending an HTTP-based request for a resource at a server; and
a variant selector selecting an available variant for the resource based on an HTTP-based response containing a list of available variants received from the server.

28. The system according to claim 27, wherein the variant selector automatically selects a variant based on one of a resolution, a frame rate, a bit-rate and a color depth.

29. The system according to claim 27, wherein a variant is manually selected at the client.

30. The system according to claim 27, wherein the resource is a scalable-encoded video resource.

31. The system according to claim 27, wherein the resource is a scalable-encoded audio resource.

32. The system according to claim 27, wherein the resource is a scalable-encoded image resource.

33. The system according to claim 27, wherein the list of available variants is based on at least one of a resolution, a frame rate and a bit-rate,

34. The system according to claim 33, wherein at least one variant is specified by a discrete value.

35. The system according to claim 33, wherein at least one variant is specified by a range of values.

36. The system according to claim 27, wherein at least one variant is represented by a Uniform Resource Locator (URL).

37. The system according to claim 36, wherein the URL is an HTTP-based URL.

38. The system according to claim 36, wherein the URL is a non-HTTP-based URL.

39. The system according to claim 27, wherein the HTTP-based response includes a header containing the list of available variants.

40. The system according to claim 39, wherein the header is an Alternates response header.

41. The system according to claim 39, wherein the header includes an extension-attributes field describing the available variants.

42. The system according to claim 27, wherein the HTTP-based response includes a header containing a URL pointing to a default variant.

43. The system according to claim 42, wherein the header is a Location header.

44. The system according to claim 42, wherein the HTTP-based response further includes an entity that further contains the list of variants.

45. The system according to claim 27, wherein the HTTP-based response includes an entity containing the list of variants.

46. The system according to claim 45, wherein the list of variants is in a plain text-based format.

47. The system according to claim 45, wherein the list of variants is in an HTML-based format.

48. The system according to claim 45, wherein the list of variants includes at least one description relating to a frame-rate, a bit-rate, a resolution, a quality and a color depth.

49. The system according to claim 27, wherein the HTTP-based response includes a features attribute describing at least one of a frame-rate, a bit-rate, a resolution and a color depth.

50. The system according to claim 27, wherein the HTTP-based response includes an extension attribute describing at least one of a frame-rate, a bit-rate, a resolution and a color depth.

51. A method for selecting a variant of a scalable-content resource, the method comprising:
receiving an HTTP-based request at a server from a client for the resource; and
generating an HTTP-based response containing a list of available variants for the resource.

52. The method according to claim 51, further comprising sending the HTTP-based response to the client.

53. The method according to claim 51, wherein the resource is a scalable-encoded video resource.

54. The method according to claim 51, wherein the resource is a scalable-encoded audio resource.

55. The method according to claim 51, wherein the resource is a scalable-encoded image resource.

56. The method according to claim 51, wherein the list of available variants is based on at least one of a resolution, a frame rate, a bit-rate and a color depth.

57. The method according to claim 56, wherein at least one variant is specified by a discrete value.

58. The method according to claim 56, wherein at least one variant is specified by a range of values.

59. The method according to claim 51, wherein at least one variant is represented by a Uniform Resource Locator (URL).

60. The method according to claim 59, wherein the URL is an HTTP-based URL.

61. The method according to claim 59, wherein the URL is a non-HTTP-based URL.

62. The method according to claim 51, wherein the HTTP-based response includes a header containing the list of available variants.

63. The method according to claim 62, wherein the header is an Alternates response header.

64. The method according to claim 62, wherein the header includes an extension-attributes field describing the available variants.

65. The method according to claim 62, wherein the HTTP-based response further includes an entity that further contains the list of variants.

66. The method according to claim 51, wherein the HTTP-based response includes a header containing a URL pointing to a default variant.

67. The method according to claim 66, wherein the header is a Location header.

68. The method according to claim 51, wherein the HTTP-based response includes an entity containing the list of variants.

69. The method according to claim 68, wherein the list of variants is in a plain text-based format.

70. The method according to claim 68, wherein the list of variants is in an HTML-based format.

71. The method according to claim 68, wherein the list of variants includes at least one description relating to a frame-rate, a bit-rate, a resolution, a quality and a color depth.

72. The method according to claim 51, further comprising sending the HTTP-based request to the server from the client; and
receiving at the client the HTTP-based response containing a list of available variants.

73. The method according to claim 72, further comprising automatically selecting at the client a variant based on one of a resolution, a frame rate, a bit-rate and a color depth.

74. The method according to claim 72, further comprising manually selecting a variant at the client.

75. The method according to claim 74, further comprising displaying the list of variants for manual selection.

76. The method according to claim 51, wherein the HTTP-based response includes a features attribute describing at least one of a frame-rate, a bit-rate, a resolution and a color depth.

77. The method according to claim 51, wherein the HTTP-based response includes an extension attribute describing at least one of a frame-rate, a bit-rate, a resolution and a color depth.

78. A method for selecting a variant of a scalable-content resource, the method comprising:
sending an HTTP-based request for a resource at a server; and
selecting an available variant for the resource based on an HTTP-based response received from the server containing a list of available variants.

79. The method according to claim 78, wherein selecting an available variant includes automatically selecting a variant based on one of a resolution, a frame rate, a bit-rate and a color depth.

80. The method according to claim 78, wherein selecting an available variant includes manually selecting a variant at the client.

81. The method according to claim 78, wherein the resource is a scalable-encoded video resource.

82. The method according to claim 78, wherein the resource is a scalable-encoded audio resource.

83. The method according to claim 78, wherein the resource is a scalable-encoded image resource.

84. The method according to claim 78, wherein the list of available variants is based on at least one of a resolution, a frame rate, a bit-rate and a color depth.

85. The method according to claim 84, wherein at least one variant is specified by a discrete value.

86. The method according to claim 84, wherein at least one variant is specified by a range of values.

87. The method according to claim 78, wherein at least one variant is represented by a Uniform Resource Locator (URL).

88. The method according to claim 87, wherein the URL is an HTTP-based URL.

89. The method according to claim 87, wherein the URL is a non-HTTP-based URL.

90. The method according to claim 78, wherein the HTTP-based response includes a header containing the list of available variants.

91. The method according to claim 90, wherein the header is an Alternates response header.

92. The method according to claim 90, wherein the header includes an extension-attributes field describing the available variants.

93. The method according to claim 90, wherein the HTTP-based response further includes an entity that further contains the list of variants.

94. The method according to claim 78, wherein the HTTP-based response includes a header containing a URL pointing to a default variant.

95. The method according to claim 78, wherein the header is a Location header.

96. The method according to claim 78, wherein the HTTP-based response includes an entity containing the list of variants.

97. The method according to claim 96, wherein the list of variants is in a plain text-based format.

98. The method according to claim 96, wherein the list of variants is in an HTML-based format.

99. The method according to claim 96, wherein the list of variants includes at least one description relating to a frame-rate, a bit-rate, a resolution, a quality and a color depth.

100. The method according to claim 78, wherein the HTTP-based response includes a features attribute describing at least one of a frame-rate, a bit-rate, a resolution and a color depth.

101. The method according to claim 78, wherein the HTTP-based response includes an extension attribute describing at least one of a frame-rate, a bit-rate, a resolution and a color depth.

102. An HTTP-based message containing a list of available variants of a resource, comprising a features attribute describing at least one of a frame-rate, a bit-rate, a resolution and a color depth relating to the available variants of the resource.

103. An HTTP-based message containing a list of available variants of a resource, comprising an extension attribute describing at least one of a frame-rate, a bit-rate, a resolution and a color depth relating to the available variants of the resource.
